(19) United States
(12) Patent Application Publication
(10) Pub. No.: US 2026/0131787 A1
(43) Pub. Date: May 14, 2026

(54) METHOD FOR ASSISTED DRIVING AND DEVICE FOR ASSISTED DRIVING, AS WELL AS VEHICLE

(71) Applicant: Volkswagen Aktiengesellschaft, Wolfsburg (DE)

(72) Inventor: Roland Kube, Wolfsburg (DE)

(21) Appl. No.: 19/382,086

(22) Filed: Nov. 6, 2025

(30) Foreign Application Priority Data
Nov. 8, 2024 (EP) 24211679.6

(51) Int. Cl. B60W 30/18; G06V 20/56

(52) U.S. Cl. CPC B60W 30/18163; G06V 20/588; B60W 2420/403; B60W 2552/30; B60W 2552/53; B60W 2556/45

(57) ABSTRACT

Technologies and techniques for assisted driving, where a method includes providing at least one item of information relating to at least one changed lane, the information including at least one interpolation point positioned along the changed lane, and verifying at least one lane marking as a function of the provided information while a vehicle negotiates the changed lane. The device includes a processor, a memory, a communication interface, and a detection unit. The processor is configured to receive the information from an external device, detect and verify lane markings based on the information, determine at least one assistance variable according to a verification result, and control an actuator in response. The vehicle includes at least one such device and may communicate with external infrastructure to enhance safety when traveling through temporarily changed lanes, such as construction zones.

### RELATED APPLICATIONS

The present application claims priority to European Patent Application EP 24211679.6, to Roland Kube, filed November 8, 2024, the contents of which are incorporated by reference in their entirety herein.

### TECHNICAL FIELD

The present disclosure relates to assisted driving. More specifically, some aspects of the present disclosure relate to a method for assisted driving, to a device configured for assisted driving, and to a vehicle comprising at least one such device.

### BACKGROUND

Modern vehicles are increasingly equipped with various driver assistance functions, such as adaptive cruise control, lane-keeping assistance, and travel assist systems. These driver assistance functions may assist a driver in maintaining a lane by providing warning signals or by performing steering interventions based on image-based detection of lane markings.

However, the lane structure in road traffic may change temporarily, for example when a vehicle is diverted around an obstacle such as a construction site. Such temporarily changed lanes often include sharp curves and lane narrowings, requiring heightened attention from the driver. Because these temporary lanes are typically marked with yellow lane markings that can be confused with permanent white lane markings, existing driver assistance functions may experience difficulty reliably detecting the correct markings. These conditions can therefore reduce the reliability and safety of assisted driving.

Accordingly, some aspects of the present disclosure are directed to providing a method for assisted driving, a device for assisted driving, and a vehicle incorporating such a device, which enhance safety during assisted driving.

### SUMMARY

The solution to the foregoing technical problem results from the subject matter defined in the independent claims. Further advantageous configurations and features of the present disclosure are set forth in the dependent claims.

In some aspects of the present disclosure, a method for assisted driving is provided. The method comprises: providing at least one item of information relating to at least one changed lane, wherein the at least one item of information includes at least one interpolation point along the changed lane; and verifying at least one lane marking as a function of the provided information, wherein the at least one lane marking is detected when a vehicle negotiates the changed lane.

In further aspects of the present disclosure, a device for assisted driving is provided. The device may be configured to perform one or more steps of the method described herein. The device may be implemented as, or include, a microprocessor or other processing unit.

In additional aspects of the present disclosure, a vehicle is provided that comprises at least one device as described herein. The vehicle may be configured as, for example, a passenger car or a truck.

The technical effects and advantages described in connection with the method also apply correspondingly to the device and the vehicle, and vice versa.

### BRIEF DESCRIPTION OF THE DRAWINGS

The present disclosure will be described in greater detail with reference to exemplary configurations. In the drawings:

FIG. 1 shows a schematic representation of an example vehicle comprising a device for assisted driving, according to some aspects of the present disclosure; and

FIG. 2 shows a schematic representation of a further example vehicle comprising a device for assisted driving, according to some aspects of the present disclosure.

### DETAILED DESCRIPTION

Hereinafter, identical reference numerals denote elements having identical technical features.

In various examples disclosed herein, the technologies and techniques described have the advantage that a detected lane marking can be verified using the provided information, thereby enhancing safety during assisted driving. In particular, the verification can ensure that a detected lane marking corresponds to a lane marking relevant to a changed lane.

The changed lane may have a progression that differs from that of an original lane. For example, the changed lane may divert a vehicle around a construction site. The changed lane may be marked by temporary yellow lane markings on a roadway and may have a curved progression. In some examples, the changed lane can have an S-shaped curvature and can include one or more segments, such as curved and/or rectilinear segments. A curved segment may, for example, be a clothoid segment.

The information may be provided by an external device. For example, at least one interpolation point may be determined by a human operator and stored in a database of the external device. The information may be provided prior to the vehicle negotiating the changed lane and/or prior to detection of the at least one lane marking so that verification of the detected lane marking can occur immediately as the changed lane is being negotiated.

The information may form part of at least one Decentralized Environmental Notification Message (DENM) and/or at least one Infrastructure-to-Vehicle Information (IVI) message. The information may further include data describing the number and/or arrangement of changed lanes. The information may also include at least one condition of the changed lane, such as characteristics of the lane markings or the presence of roadway damage, since the condition of the changed lane may significantly influence the safety with which the lane can be negotiated. The information, and in particular the at least one interpolation point, may be defined with respect to a reference coordinate system.

The reference coordinate system may be a Cartesian coordinate system that is stationary and defined by a longitudinal axis, a transverse axis, and a vertical axis. The longitudinal axis may be oriented in the driving direction of the vehicle and may be referred to as the longitudinal direction. The transverse axis may be oriented orthogonal to both the longitudinal and vertical axes and may be referred to as the lateral direction. The vertical axis may be oriented orthogonal to the longitudinal and transverse axes and may be oriented opposite the direction of gravity, defining the vertical direction.

The at least one interpolation point may be defined as a coordinate or set of coordinates with respect to the reference coordinate system. The interpolation point may be positioned, for example, at a center or at an edge of the changed lane in the lateral direction, or at the location of an actual lane marking. The information may include multiple interpolation points. For example, a first interpolation point may be positioned at the beginning of the changed lane in the longitudinal direction, and at least one additional interpolation point may be offset from the first interpolation point along the progression of the changed lane or along the lane marking. The offset may be defined in the longitudinal, lateral, and/or vertical directions, the latter accounting for height differences along the changed lane.

The device and/or vehicle may be configured to detect at least one lane marking using an image-recording device, such as a camera, and/or a detection device operating based on a machine learning algorithm. The at least one lane marking may be recorded, detected, and verified while the changed lane is being negotiated. The method may optionally comprise steps of recording and/or detecting the lane marking. Because temporarily changed lanes can include both white and yellow markings, simultaneous detection of multiple markings may occur, with verification distinguishing between relevant and non-relevant lane markings.

The verification may be carried out by using the provided information as a reference for the detected lane marking. For example, a position of the detected lane marking may be compared with a position of the interpolation point. The detected lane marking may be verified when its position deviates from the interpolation point by no more than a predetermined threshold value. Other components of the provided information may also be used in the verification, as discussed in more detail below.

The verification result may indicate, for example, whether a detected lane marking is to be retained or discarded. In particular, a detected first lane marking (for example, a yellow marking) may be classified as relevant and therefore retained, whereas another simultaneously detected marking (for example, a white marking) may be classified as irrelevant and therefore disregarded.

The verification of the detected lane marking may be performed by the device and/or the vehicle, allowing internal computing resources to be used for verification.

Furthermore, the provided information may replace an original reference that is otherwise used to verify the detected lane marking. The original reference may, for example, be a satellite image showing lane markings. Since such an original reference may be outdated and show markings that are no longer current, replacing it prevents outdated reference data from being used in the verification process.

In some examples of the present disclosure, the provided information may further include at least one lane width of the changed lane. In this manner, the detected lane marking can additionally be verified as a function of the lane width, since lane width affects the actual positions of the lane markings. The lane width may, for example, correspond to the distance between two lane markings of the changed lane or to the width of the changed lane at the interpolation point.

In some examples, the information is transmitted from at least one external device to the vehicle, and the vehicle receives the information. This allows the information to be provided immediately before the changed lane is negotiated. The external device may include at least one microcontroller and/or one active communication element, such as a radio transmitter or another communication interface. The external device may form part of a traffic infrastructure. For instance, the external device may be located on a construction vehicle parked in the vicinity of the changed lane. Alternatively, the external device may be a server that provides the information and transmits it to the vehicle via the Internet.

The vehicle and/or the device may include a microcontroller and/or a passive communication element, such as a radio receiver or other communication interface. The vehicle or the device may use the passive communication element to receive the information. The provided information may be transmitted locally, with a transmission range of, for example, up to 100 meters, 500 meters, 1000 meters, or 2000 meters.

In some examples, transmission of the information is preceded by transmission of a first message that announces or references at least one subsequent message, wherein the provided information forms part of the subsequent message. This arrangement can make the provision of information more robust, allowing the device to prepare for receiving the information. For instance, the device may clear or format a working memory prior to reception. The first message may require less memory space than the subsequent message.

The first message may, for example, be a Decentralized Environmental Notification Message (DENM), since DENM provides a compact format suitable for rapid and reliable transmission. The subsequent message may be an Infrastructure-to-Vehicle Information (IVI) message, which allows transmission of more extensive data, such as a large number of interpolation points. A reference between the first and subsequent messages may be established using a sequence of digits included in both messages to facilitate association. The external device may be configured to transmit both the first and subsequent messages, and the device and/or the vehicle may be configured to receive both.

In some examples, at least one assistance variable is determined as a function of the provided information and/or as a function of a result of the verification. This makes negotiation of the changed lane safer. The assistance variable may be determined by assigning the provided information and/or verification result to one or more predefined assistance variables according to an assignment rule that may be derived from experiments or simulations.

The determined assistance variable may include at least one of the following parameters: a target movement of the vehicle for assisted driving in the changed lane (for example, a target acceleration, target speed, target steering angle, or target steering-angle rate); a target lane for the vehicle (for example, when multiple changed lanes are available); and/or a progression of the changed lane.

In particular, the determined assistance variable may be set or applied so that it can be used for assisted driving. The device may include an actuator for setting the assistance variable. The assistance variable may be implemented by adjusting an actual variable of the vehicle—such as speed—so that the deviation between the actual and target values remains within a predefined threshold. Alternatively, the assistance variable may be output as information, such as a warning or recommendation to the driver, or as a visualization of the progression of the changed lane. The vehicle and/or the device may include a display unit, such as a screen or a freely programmable instrument cluster, for outputting the assistance variable.

In some examples, the verification may be performed as a function of at least one of the following vehicle-specific variables: the width, height, and/or length of the vehicle; a current lane of the vehicle; an actual location of the vehicle; an actual movement of the vehicle; a vehicle feature; and/or a planned route guidance of the vehicle. Considering these variables can make the verification more robust, as they significantly influence how the changed lane is negotiated and which lane markings must be verified. The vehicle-specific variables may be previously known.

In particular, the assistance variable may also be determined as a function of at least one vehicle-specific variable. For example, the vehicle’s width, height, and/or length may affect which of several changed lanes is most suitable to negotiate. A lane may be too narrow for the vehicle, in which case the vehicle width may be compared with the lane width of the changed lane. Similarly, a lane change from the current lane to the changed lane may be required when the current lane ends. Certain vehicle features—such as a non-standard assistance function—may make a particular lane more suitable. Additionally, planned route guidance may require selecting a left changed lane instead of a right changed lane.

In some examples, at least one curvature of the changed lane may be determined as a function of the provided information. In this manner, a curved progression of the changed lane can be taken into account when verifying detected lane markings and/or determining the assistance variable. The curvature may correspond to that of a segment of the changed lane or of the roadway surface itself. The curvature may be oriented in a horizontal plane (for example, spanned by the longitudinal and transverse axes) and/or a vertical plane (for example, spanned by the longitudinal and vertical axes or the transverse and vertical axes).

The curvature may be determined using curve-fitting techniques, such as polynomial regression. Determining curvature may include determining the progression of the changed lane by connecting multiple interpolation points using at least one function, such as a polynomial function, representing the lane progression. The curvature may then be obtained as a local derivative of that function and may be determined at one or more points along the changed lane.

In some examples, the provided information may be reviewed or validated by at least one additional vehicle that negotiates the changed lane. This allows confirmation of the correctness of the provided information. The additional vehicle may include an embodiment of the device described herein and may include means for reviewing the provided information, such as a position-determination unit configured to determine and compare the positions of the interpolation points.

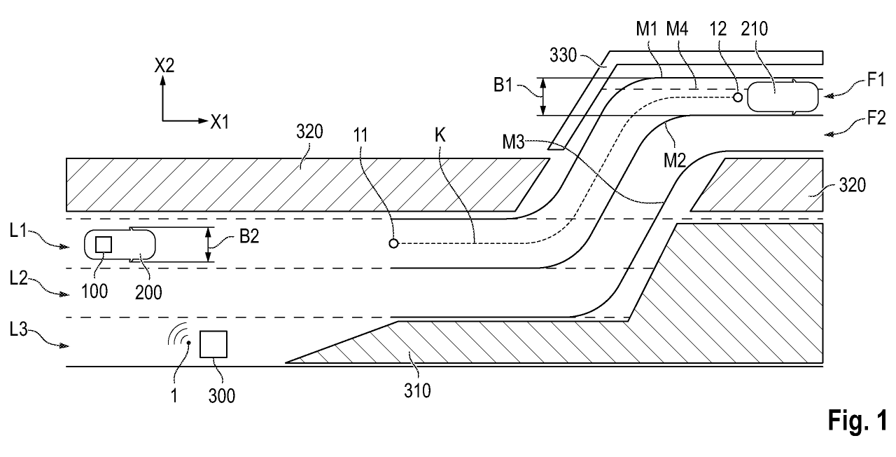

FIG. 1 shows a schematic representation of an example vehicle 200 comprising a device 100 for assisted driving in an exemplary traffic situation, according to some aspects of the present disclosure.

In the traffic situation illustrated, the vehicle 200 is traveling on a highway in a lane L1, with the highway generally comprising three lanes L1, L2, and L3. The lanes L1–L3 are delimited by lane markings, indicated by dashed lines in FIG. 1.

The vehicle 200 is configured to communicate with an external device 300 by way of the device 100. The external device 300 may be a construction vehicle parked in lane L3 and configured to emit information 1 locally in the form of a combination of a Decentralized Environmental Notification Message (DENM) and an Infrastructure-to-Vehicle Information (IVI) message to the approaching vehicle 200. Alternatively, the information 1 may be transmitted solely as a DENM message or solely as an IVI message. Communication between the external device 300 and the vehicle 200 may occur in near real-time.

In one example, the external device 300 may have a transmission range of up to approximately 1000 meters, allowing it to transmit the information 1 to the vehicle 200 as early as one kilometer before the start of a construction site 310. The construction site 310 is indicated in FIG. 1 by a hatched area.

The external device 300 may also indicate—such as via a display panel (not shown)—that lane L3 terminates due to the construction site 310 and that vehicles approaching in lane L3 must initiate a lane change.

The remaining lanes L1 and L2 transition into changed lanes F1 and F2. These changed lanes F1 and F2 cross a median strip 320 (likewise hatched in FIG. 1) of the highway by way of an S-shaped curve identified by dotted lines, having a curvature K. The changed lanes F1 and F2 thus allow vehicles to bypass the construction site 310.

After crossing the median strip 320, the changed lanes F1 and F2 merge into an area originally used for oncoming traffic (not shown), which is separated from the opposing direction by a concrete barrier 330. In this area, an original lane marking M4 (indicated by a dashed line) remains. Although the original lane marking M4 is not relevant for the changed lanes F1 and F2, it may nonetheless be detected by the vehicles 200 and 210 as a lane marking.

In contrast, the changed lanes F1 and F2 are delimited by temporary lane markings M1, M2, and M3, shown as solid lines in FIG. 1. These temporary lane markings M1–M3 can also be detected as lane markings by the vehicles 200 and 210. Some aspects of the present disclosure enable the system to distinguish the irrelevant original lane marking M4 from the relevant temporary lane markings M1–M3 by using the provided information 1 to verify the detected markings.

For spatial orientation, FIG. 1 illustrates a reference coordinate system having a longitudinal axis X1 and a transverse axis X2. The longitudinal axis X1 is oriented in the driving direction of the vehicle 200, defining the longitudinal direction. The transverse axis X2 is oriented orthogonal to the longitudinal axis X1, defining the lateral direction.

The information 1 emitted by the external device 300 includes a first interpolation point 11 and a second interpolation point 12, both represented in FIG. 1 by solid circles. These interpolation points mark the beginning and end of the S-curve having curvature K. The interpolation points 11 and 12 may be measured, for example, by a metrology engineer and stored in a database (not shown) of the external device 300.

The first interpolation point 11 may correspond to a coordinate in the reference coordinate system and may represent the position of the center of the changed lane F1 at the start of the S-curve. The second interpolation point 12 may likewise correspond to a coordinate in the reference coordinate system and may represent the position of the center of the changed lane F1 at the end of the S-curve. The interpolation point 12 is offset from interpolation point 11 in both the lateral and longitudinal directions. The information 1 may also include the stationary origin of the reference coordinate system.

The information 1 further includes a lane width B1 of lane F1, since lane F1 is narrower than the lanes L1–L3. The lane width B1 may be compared with a vehicle width B2 of the vehicle 200 to determine whether the vehicle 200 can safely negotiate lane F1.

Lane F1 is also negotiated by a further vehicle 210 that includes an identical device 100. The further vehicle 210 has already received the information 1 and reviews the validity of the information 1 while negotiating lane F1. For example, the further vehicle 210 may determine the positions of interpolation points 11 and 12 using a position-determination device (not shown) and use the results to verify the accuracy of the provided information 1.

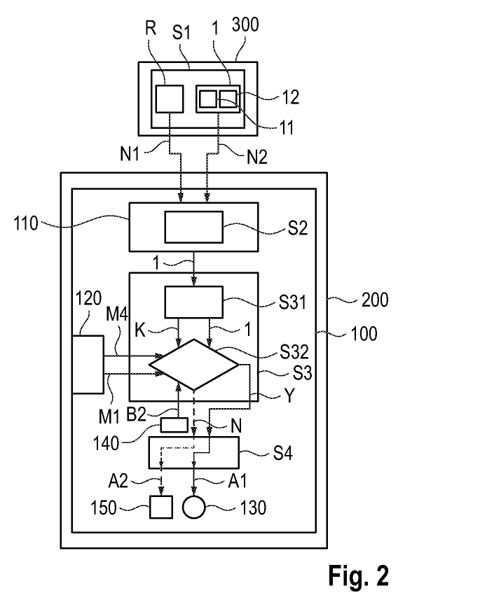

FIG. 2 shows a schematic representation of another example vehicle 200 comprising a device 100 for assisted driving, according to some aspects of the present disclosure.

The devices 100 illustrated in FIGS. 1 and 2 may each be configured to perform a method for assisted driving in accordance with examples of the present disclosure. The method illustrated in FIG. 2 comprises the steps described below.

In step S1, information 1 relating to at least one changed lane F1 is provided. The information 1 includes multiple interpolation points 11 and 12 (see FIG. 1). These interpolation points 11, 12 may be stored, for example, in a database of an external device 300.

The external device 300 is configured to announce transmission of the information 1 to the vehicle 200 by transmitting a first message N1, which may be implemented as a Decentralized Environmental Notification Message (DENM). The first message N1 prepares the device 100, or software executed by the device 100, to receive a subsequent message N2.

The first message N1 may reference the subsequent message N2 using a digit sequence R. The digit sequence R may represent, for example, a memory requirement of the subsequent message N2 and may be contained in a road works container of the first message N1. Upon receiving the first message N1, a working memory (not shown) of the device 100 may be cleared to buffer the subsequent message N2. The subsequent message N2 may be implemented as a memory-intensive Infrastructure-to-Vehicle Information (IVI) message, in which the information 1 forms a portion of the message together with additional data (not shown).

The subsequent message N2 may further include information relevant to the vehicle’s surroundings and current traffic situation, such as data describing road signs, traffic regulations, warnings, or speed limits associated with different sections of the changed lanes F1 and F2.

In step S2, the information 1 is transmitted from the external device 300 to the vehicle 200 and received by the vehicle through a wireless communication interface 110. The received information 1 may be temporarily stored in the working memory (not shown) of the device 100.

While the vehicle 200 negotiates the changed lane F1, lane markings M1 and M4 (see FIG. 1) may be detected. To accomplish this, the device 100 may include an image-recording device (not shown) and a detection device 120 implemented, for example, as a microcontroller.

In step S3, the detected lane markings M1 and M4 are verified. Step S3 comprises multiple sub-steps S31 and S32, described in further detail below.

In sub-step S31, a curvature K of the changed lane F1 is determined as a function of the information 1. The curvature K may be determined using curve-fitting techniques that connect interpolation points 11 and 12 with a polynomial function. The curvature K may be derived as a local derivative of the polynomial function. The determined curvature K can be used to better distinguish between lane markings M1 and M4, since the curvature K of the changed lane F1 should substantially correspond to the curvature of the detected lane marking M1, whereas the original lane marking M4 is rectilinear and lacks curvature.

A vehicle-specific variable, such as a width B2 of the vehicle 200, may also be used during verification of the lane markings M1 and M4. The width B2 may be stored in a memory 140 of the device 100 and retrieved for this purpose. The width B2 may serve as an additional reference parameter in verifying the detected lane markings.

In sub-step S32, the detected lane markings M1 and M4 are verified as a function of the received information 1, the previously determined curvature K, and the vehicle-specific variable of the vehicle 200.

The temporary lane marking M1 may be verified by comparing the position of the center of the changed lane F1 (see FIG. 1), as indicated by interpolation point 12, with the position of the detected lane marking M1. If the positional difference is less than a predetermined threshold value, the lane marking M1 is classified as relevant to the changed lane F1. In contrast, the original lane marking M4 (see FIG. 1), which may also be detected, can be classified as irrelevant to the changed lane F1 and discarded when the threshold value is exceeded. This verification allows the relevant lane marking M1 to be distinguished from the irrelevant lane marking M4. The result Y of sub-step S32 is positive when such distinction is achieved. Conversely, if no distinction can be made between the detected lane markings M1 and M4, the result N of sub-step S32 is negative.

In step S4, an assistance variable A1 is determined as a function of the result Y. The assistance variable A1 may correspond, for example, to a target steering angle that is set when the verification result Y is positive. The assistance variable A1 may be implemented by an actuator 130 of the device 100, such as an electric motor.

If the verification result N is negative, an alternative assistance variable A2 may be determined and output as a warning to a display device 150 of the device 100, which may be implemented as a screen. The warning may notify the driver of the vehicle 200 that verification of the detected lane markings M1 and M4 is currently not possible and that, consequently, the assistance variable A2 cannot presently be set.

### LIST OF REFERENCE NUMERALS

1 piece of information

11 first interpolation point

12 further interpolation point

100 device

110 communication interface

120 detection device

130 actuator

140 memory

150 display device

200 vehicle

210 further vehicle

300 external device

310 construction site

320 median strip

330 concrete barrier

A1 assistance variable

A2 further assistance variable

B1 width of a changed lane

B2 width of a vehicle

F1 and F2 changed lane

K curvature of a changed lane

L1 to L3 lane

M1 to M3 temporary lane marking

M4 original lane marking

N negative result of the verification

N1 first message

N2 further message

R digit sequence

S1 step

S2 step

S3 step

S31 sub-step

S32 sub-step

S4 step

X1 longitudinal axis

X2 transverse axis

Y positive result of the verification

1. A method for assisted driving, comprising:
providing, by a processor of a vehicle, at least one item of information relating to at least one changed lane, the at least one item of information including at least one interpolation point positioned along the at least one changed lane; and
verifying, by the processor, at least one lane marking as a function of the provided at least one item of information,
wherein the at least one lane marking is detected while the vehicle negotiates the at least one changed lane.

2. The method of claim 1, wherein the provided at least one item of information further includes at least one lane width of the at least one changed lane, and wherein verifying the at least one lane marking comprises verifying the at least one lane marking as a function of the at least one lane width.

3. The method of claim 1, wherein the at least one item of information is transmitted from an external device to the vehicle, and wherein the at least one item of information is received by the vehicle.

4. The method of claim 3, wherein transmission of the at least one item of information is preceded by transmission of a first message that references a further message, and wherein the at least one item of information is contained in the further message.

5. The method of claim 1, further comprising determining at least one assistance variable based on at least one of: the provided item of information, or a result of the verifying of the at least one lane marking.

6. The method of claim 5, wherein determining the at least one assistance variable comprises at least one of:
setting a target steering angle, target acceleration, target speed, or target steering-angle rate of the vehicle;
selecting a target lane for the vehicle; or
determining a progression of the at least one changed lane.

7. The method of claim 1, wherein verifying the at least one lane marking further comprises performing the verification as a function of at least one vehicle-specific variable comprising at least one of:
a width, height, or length of the vehicle;
a current lane of the vehicle;
an actual location of the vehicle;
an actual movement of the vehicle, including an actual speed;
a feature of the vehicle; or
a planned route guidance of the vehicle.

8. The method of claim 1, further comprising determining a curvature of the at least one changed lane as a function of the at least one item of information, wherein the curvature corresponds to a progression of the at least one changed lane.

9. The method of claim 1, further comprising reviewing the at least one item of information by a further vehicle as the further vehicle negotiates the at least one changed lane.

10. A device for assisted driving, comprising:
a memory storing program instructions and data;
a processor operatively coupled to the memory and configured to execute the program instructions;
a communication interface configured to exchange information with an external device; and
a detection unit configured to detect at least one lane marking while a vehicle negotiates at least one changed lane;
wherein the processor is configured to:
receive, through the communication interface, at least one item of information relating to the changed lane, the at least one item of information including at least one interpolation point positioned along the changed lane; and
verify the detected at least one lane marking as a function of the received at least one item of information.

11. The device of claim 10, wherein the at least one item of information further includes at least one lane width of the changed lane, and wherein the processor is further configured to verify the detected lane marking as a function of the at least one lane width.

12. The device of claim 10, wherein the communication interface is further configured to receive the at least one item of information transmitted from an external device forming part of a traffic infrastructure.

13. The device of claim 12, wherein the communication interface is further configured to:
receive a first message that references a further message; and
receive the at least one item of information contained in the further message.

14. The device of claim 10, further comprising an actuator operatively coupled to the processor, the actuator being configured to adjust a vehicle control parameter,
wherein the processor is configured to determine at least one assistance variable based on at least one of the received item of information and a result of the verification, and to control the actuator according to the determined assistance variable.

15. The device of claim 14, wherein the actuator is configured to adjust at least one of:
a steering angle, a vehicle acceleration, a vehicle speed, or a steering-angle rate;
and wherein the processor is further configured to select a target lane or determine a progression of the changed lane.

16. The device of claim 10, wherein the processor is further configured to perform the verification as a function of at least one vehicle-specific variable comprising at least one of:
a width, height, or length of the vehicle;
a current lane of the vehicle;
an actual location of the vehicle;
an actual movement of the vehicle, including an actual speed;
a feature of the vehicle; or
a planned route guidance of the vehicle.

17. The device of claim 10, wherein the processor is further configured to determine a curvature of the changed lane as a function of the received item of information, the curvature corresponding to a progression of the changed lane.

18. The device of claim 10, wherein the processor is further configured to review the received item of information by comparing positions of interpolation points determined by at least one further vehicle negotiating the changed lane.

19. A vehicle comprising:
at least one device for assisted driving according to claim 10, the at least one device including
a memory storing program instructions and data,
a processor operatively coupled to the memory and configured to execute the program instructions,
a communication interface configured to exchange information with an external device, and
a detection unit configured to detect at least one lane marking while the vehicle negotiates at least one changed lane;
wherein the processor is configured to:
receive, through the communication interface, at least one item of information relating to the changed lane, the at least one item of information including at least one interpolation point positioned along the changed lane; and
verify the detected at least one lane marking as a function of the received at least one item of information.

20. The vehicle of claim 19, further comprising an actuator operatively coupled to the processor of the at least one device,
wherein the processor is configured to determine at least one assistance variable based on a verification result of the detected lane marking and to control the actuator according to the determined assistance variable,
the actuator being configured to adjust at least one of: a steering angle, a vehicle acceleration, a vehicle speed, or a steering-angle rate.
